(19) United States
(12) Patent Application Publication
(10) Pub. No.: US 2003/0187685 A1
(43) Pub. Date: Oct. 2, 2003

(54) Customer acquisition in a loyalty system

(75) Inventor: Anton Bakker, Norfolk, VA (US)

Correspondence Address: NIXON PEABODY, LLP, 8180 GREENSBORO DRIVE, SUITE 800, MCLEAN, VA, 22102, US

(73) Assignee: Outside Networks, Inc., Norfolk, VA

(21) Appl. No.: 10/396,499

(22) Filed: Mar. 26, 2003

Related U.S. Application Data
(60) Provisional application No. 60/367,493, filed on Mar. 27, 2002.

(51) Int. Cl. G06F 17/60

(52) U.S. Cl. 705/1

(57) ABSTRACT

Through determining one or more of the presence and attributes related to a customer, specific content is retrieved and presented to a customer. This content can be directed toward securing the customer as a member of a loyalty system. Alternatively, for example, the content can be dynamically chosen and delivered to a customer based on, for example, one or more preferences in a customer profile.

### RELATED APPLICATION DATA

This application claims the benefit of and priority under 35 U.S.C. §119(e) to U.S. patent application Ser. No. 60/367,493, filed Mar. 27, 2002, entitled “Automatic Customer Acquisition in a Loyalty System,” which is incorporated herein by reference in its entirety.

### BACKGROUND OF THE INVENTION

1. Field of the Invention

This invention generally relates to customer acquisition. In particular, this invention relates to systems and methods for customer acquisition in, for example, a loyalty system environment.

2. Description of Related Art

Loyalty systems reward a customer for frequent use of a company's services, frequent purchasing of a company's goods, or the like. For example, frequent flyer miles are a prime example of how air lines reward passengers for traveling on their particular airline. The reward, based on a number of “miles” accumulated can vary from discounts on future airline tickets, to seat upgrades, to free tickets, or the like.

Loyalty systems are becoming more popular as a retail mechanism for obtaining and retaining customers. Before employing a loyalty system, a retailer must decide if the benefits outweigh the costs. One of the most significant costs is that of customer acquisition.

Customer acquisition is the process of convincing a current or potential customer to become a participating loyalty member. This is often done using the traditional advertising techniques of flyers, mailers, in-store literature, posters, and/or radio, television or print advertisements. Theses techniques can be extremely expensive, which has a direct impact of the overall return of the loyalty system. If the cost to acquire the customer as a member is more than the retailer could earn from that customer, it defeats the point of having a loyalty system in the fist place.

### SUMMARY OF THE INVENTION

The exemplary systems and methods of this invention can be used, for example, as part of a loyalty system, or in general any system where there is an attempt to encourage potential participants to join. For example, an exemplary result of the systems and methods of this invention are to reduce the effective costs associated with customer acquisition and to automate the customer acquisition process to, for example, expand the loyalty base.

For example, the systems and methods of this invention are designed to operate as part of a loyalty system that is able to sense the presence of a customer and to deliver a content based on whether that customer is identified as a member of the system.

For example, in accordance with an exemplary embodiment, a customer identified as a member requires no additional acquisition. However, if the customer is identified as not being a member, the systems and methods of this invention perform a specific task based on this identification. For example, for these non-member customers, the exemplary systems and methods of this invention attempt to entice the customer to become a member of the loyalty system through, for example, either an audio, video, multimedia, or the like, message.

Non-member customers can be identified as such by, for example, the customer's failure to identify themselves as a member customer within, for example, a specific amount of time. If subsequent to being identified as a non-member customer, the customer does identify themselves to the system as a member customer, the acquisition system could, for example, halt presentation of the current content, and switch to a mode of operation appropriate for a member of customers.

Accordingly, the systems and methods of this invention facilitate customer acquisition.

Aspects of the invention also relate to facilitating customer acquisition in a loyalty system.

Aspects of the invention further relate to determining and delivering content based on a customer's identification.

Aspects of the invention additionally relate to configuring a customer acquisition system for use in a particular environment.

These and other features and advantages of this invention are described in, or are apparent from, the following detailed description of the embodiments.

### BRIEF DESCRIPTION OF THE DRAWINGS

The embodiments of the invention will be described in detailed, with reference to the following figures, wherein:

FIG. 1 is a functional block diagram illustrating an exemplary customer acquisition system according to this invention;

FIG. 2 is a screen shot of a exemplary graphical user interface that can be used to program the customer acquisition system according to this invention;

FIG. 3 is a flowchart illustrating an exemplary method for interfacing with a customer according to this invention; and

FIG. 4 is a flowchart illustrating a second exemplary method for interfacing with a customer according to this invention.

### DETAILED DESCRIPTION OF THE INVENTION

The exemplary systems and the methods of this invention will be described in relation to customer acquisition systems in general. However, to avoid unnecessarily obscuring the present invention, the following description omits well-known structures and devices that may be shown in block diagram form or otherwise summarized. For the purposes of explanation, numerous specific details are set forth in order to provide a thorough understanding of the present invention. It should be appreciated however that the present invention may be practiced in variety of ways beyond the specific details set forth herein. For example, the systems and methods of this invention can be scaled to any level and are capable of working in conjunction with any type of customer.

Furthermore, while the exemplary embodiments illustrated herein show the various components of the customer acquisition system collocated, it is to be appreciated that the various components of the system can be located at distant portions of a distributed network, such as a WAN and/or the Internet, or within a dedicated customer acquisition system. Thus, it should be appreciated that the components of the customer acquisition system can be combined into one or more devices or collocated on a particular node of a distributed network, such as a communications network. It will be appreciated from the following description, and for reasons of computational efficiency, that the components of the customer acquisition system can be arranged at any location within a distributed network without affecting the operation of the system.

Additionally, it should be appreciated that the various links connecting the elements can be wired or wireless links, or any combination thereof, or any other known or later developed element(s) that is capable of supplying and/or communicating data to and from the connected elements. Additionally, the term module as used herein can refer to any known or later developed hardware, software, or combination of hardware and software that is capable of performing the functionality associated with that element. Likewise, for example, to facilitate scaling of the system, one or more components of the customer acquisition system can be mirrored at one or more locations.

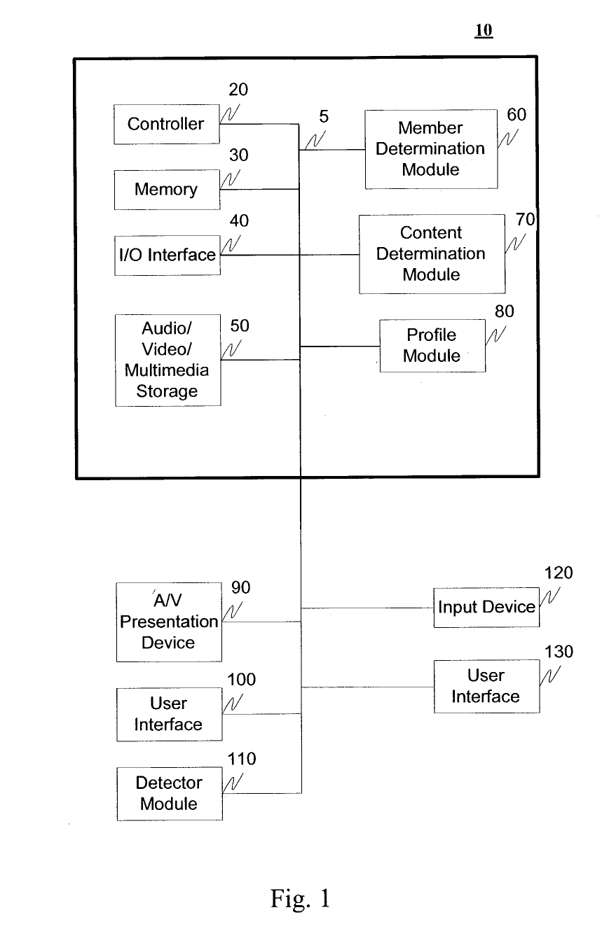

FIG. 1 illustrates an exemplary customer acquisition system 10. The customer acquisition system 10 comprises a controller 20, a memory 30, an I/O interface 40, an audio/video/multimedia storage 50, a member determination module 60, a content determination module 70 and a profile module 80, connected via link 5. The customer acquisition system 10 also comprises an A/V presentation device 90, a user interface 100, a detector module 110, an input device 120 and user interface 130, again connected via link 5.

In operation, a user, via the input device 120 and the user interface 130, interfaces with the content determination module 70, and the audio/video/multimedia storage 50. In particular, a user, such as a customer acquisition manager, initializes the system by identifying one or more portions of content that will be associated with an activity, or lack thereof, at the customer acquisition system 10. For example, the user can specify specific content to be displayed to a customer, specific content for a member, or, for example, generic content to be continuously disseminated. Upon establishing the various type of content the customer acquisition system 10 will distribute to various customers, as discussed herein below, the system can be placed in operation.

Specifically, the detector module 110 can detect the presence of a customer. For example, the detector module 110 can be a proximity detector, such as an electrical, electro-mechanical, magnetic, inductive, capacitive, and/or optical detector, a credit card reader, a switch, an RFID device, or in general any device that is capable of indicating to the customer acquisition system 10 that a customer is present. For example, the presence of a user can be triggered by the user activating a gas pump, or the like. Upon detecting the presence of a customer, the customer acquisition system 10, in cooperation with the controller 20, memory 30, I/O interface 40 and member determination module 60, attempts to determine if the customer is a member of the loyalty system. For example, member determination module 60 can look at any information acquired from the customer, such as credit card information, swipe tag information, PIN information, license plate detection information, fingerprint information, or an indication from the customer, for example, via the user interface 100, to determine whether the customer is a member. Based on this determination, and in cooperation with the content determination module 70, the customer acquisition system 10 determines what type of content, if any, should be presented to the customer.

If content is to be presented, the content determination module 70 cooperates with the audio/video/multimedia storage 50 along with the controller 20, memory 30 and I/O interface 40 to deliver the content via the A/V presentation device 90 to the customer. Alternatively, the content determination module 70 can be connected to, for example, one or more streams of content (not shown), e.g., news, radio, or the like, that could also be displayed on the presentation device 90 in real or near real time. Furthermore, the content determination module 70 can work in cooperation with the profile module 80 to further assist in identifying specific content to be provided to a customer. For example, the profile module 80 can store information such as customer loyalty, preference, order placement, and history data that may be associated with a customer. For example, the profile module 80 can cooperate with the content determination module 70 to determine the type of content, if any, to presented to a customer based on the current transaction, the history of transactions associated with the particular customer, a reward system, a promotion, or the like. For example, the systems and methods of this invention can work in conjunction with U.S. patent application Ser. No. 10/137,375 entitled “Systems And Methods For The Identification and Displaying Of Information,” which is incorporated herein by reference in its entirety.

Upon the content determination module 70 determining the type of content to be presented to a customer, with the cooperation the audio/video/multimedia storage 50, I/O interface 40, memory 30, controller 20 and A/V presentation device 90, the content determination module 70 presents the content to the customer.

As discussed previously, the customer acquisition can be scaleable as well as dynamic. For example, one or more of the user interface 100 and detector module 110 can monitor customer activities at the customer acquisition system 10. For example, if the customer purchases a predetermined amount of a particular product, appears to be interested in more information on a particular portion of content, for example by pressing a “Request More Information” button (not shown) on the user interface 100, or the like, the content determination module 70 can interject and, for example, in cooperation with member determination module 60 and profile module 80 determine supplemental content, if any, to be presented to the customer. In one exemplary embodiment, generic content could be streaming to the A/V presentation device 90. Upon the detector module 110 detecting the presence of a customer within a specific area of the A/V presentation device 90, the customer acquisition systems 10 streams a first type of content. During the presentation of the content, the controller 20 can maintain information about the playback location in the content containing specific information about, for example, one or more promotions. Then, if the detector module 110 detects that the customer has triggered, for example by approaching, for example the A/V presentation device to, for example, see or hear more clearly specific content, the customer acquisition system 10 can dynamically detect the change in status of the customer and the content determination module 70 could modify subsequent content, by, for example, forwarding detailed content that corresponds to the information being presented when the customer approached the A/V presentation device 90.

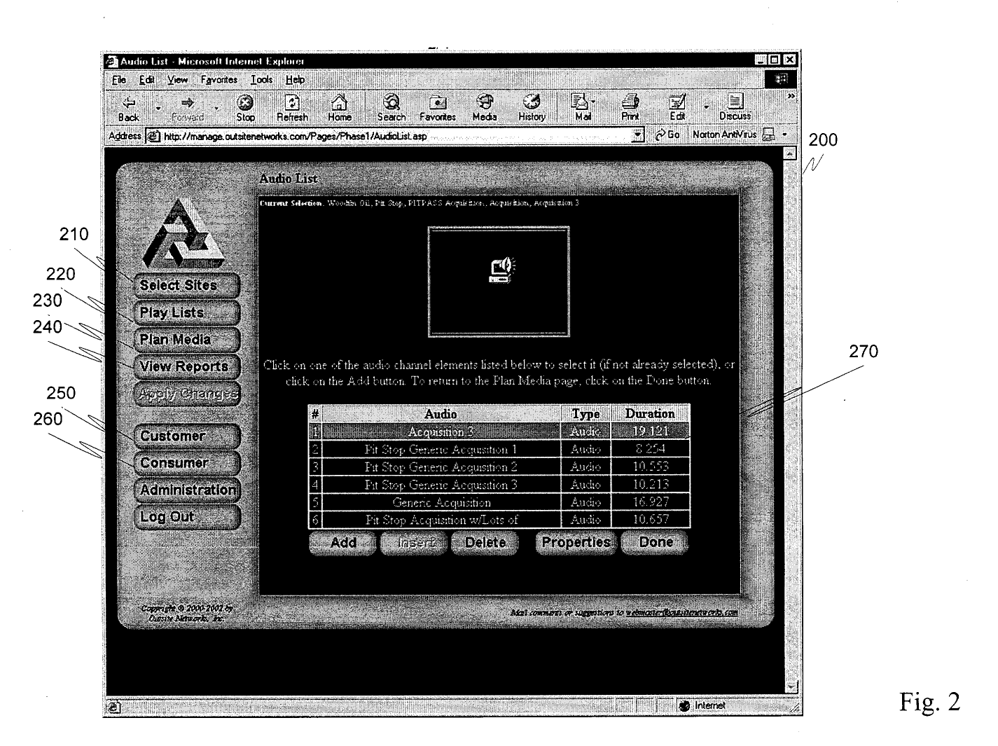

FIG. 2 illustrates an exemplary user interface 200 that could be displayed on the user interface 130. Then, via the input device 120, such as a mouse or the like, the user selects and/or configures the various types of content that are to be presented based on events at the customer acquisition system 10. Specifically, selectable portion 210 allows the user to select a site, or a group of sites, such as a gas station(s), kiosk(s), grocery store(s), department store(s), convenience store(s), any point of sale, or the like, to configure the type of content to be displayed to a customer at that site(s). Additionally, group manipulation of multiple associated sites is also possible through this interface with selections being applied to multiple or grouped sites. Specifically, via the selectable portion 220, a user selects the play list and in cooperation with selectable portion 230 determines the sequence of content that should be played at the selected site. Then, as illustrated in portion 270, the available audio/video/multimedia content portions can be selected and associated with the specific event at the customer acquisition system 10. User interface 200 can further include a selectable portions 250 and 260 that are administrative buttons that allow the selection or modification of properties of customers, e.g., retailers, customer acquisition customers, or the like, and consumers, e.g., tag holders, or the like. For example, through the selectable portion 250 high level parameters for the system, such as point allotments, personal information, and the like, can be manipulated. Likewise, comparable customer properties can be manipulated through the selectable portion 260. Furthermore, the user interface 200 can allow access to reports via the selectable portion 240 that can, for example, provide specifics such as what content was presented, when the content was presented, whether the presentment of the content resulted in the customer selecting to become a member of the customer acquisition system, or any other information as appropriate.

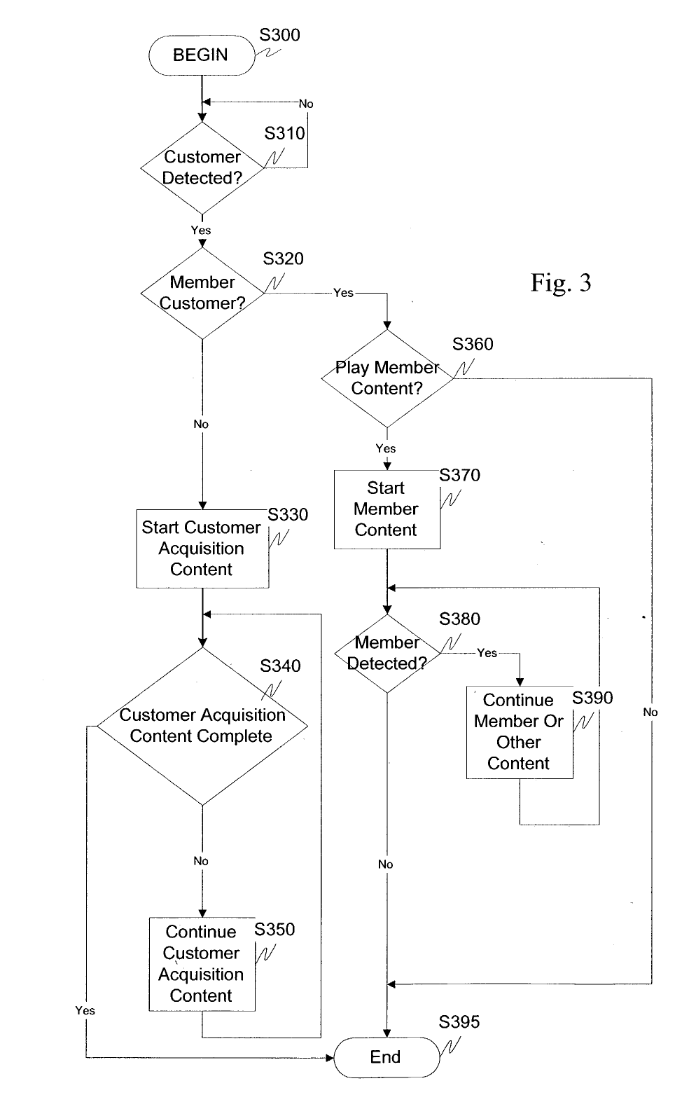

FIG. 3 illustrates an exemplary flowchart of the customer acquisition system in accordance with this invention. In particular, control begins in step S300 and continues to step S310. In step S310, a determination is made whether a customer has been detected. If a customer has not been detected, control jumps back to step 310. Otherwise, control continues to step S320. In step S320, a determination is made whether the customer is a member. If the customer is a member, control continues to step S360. Otherwise, control jumps to step S330.

In step S360, a determination is made whether content for members should be played. If the content is to be played, control continues to step S370. Otherwise, control jumps to step S395 where the control sequence ends.

In step S370, the presentation of member content commences. Next, in step S380 a determination is made whether the member is still present. If the member is still present, control continues to step S390. Otherwise, control jumps to step S395 where the control sequence ends. In step S390, content continues to be presented to the member. Control then jumps back to step S380.

In step S330, customer acquisition content begins playing. Next, in step S340, a determination is made whether the customer acquisition content is complete. Alternatively, a determination can be made whether the customer has opted to become a member. If the customer has opted to become a member, specific content may be played before the control sequence ends. If in step S340 the customer acquisition content is complete, control jumps to step S395. Otherwise, control continues to step S350 where the customer acquisition content continues. Control then jumps back to step S340.

While the flowchart illustrated in FIG. 3 shows a very basic exemplary operation of a customer acquisition system, it is to be appreciated that various dynamic features can be interjected in this operational flow to allow increased functionality and, for example, more sophisticated methods of determining content to be presented. For example, as previously discussed, various actions by the customer can be monitored to dynamically adjust content. Alternatively, the system can adapt to customer requests, for example, where a customer does not want to hear content such as member acquisition messages.

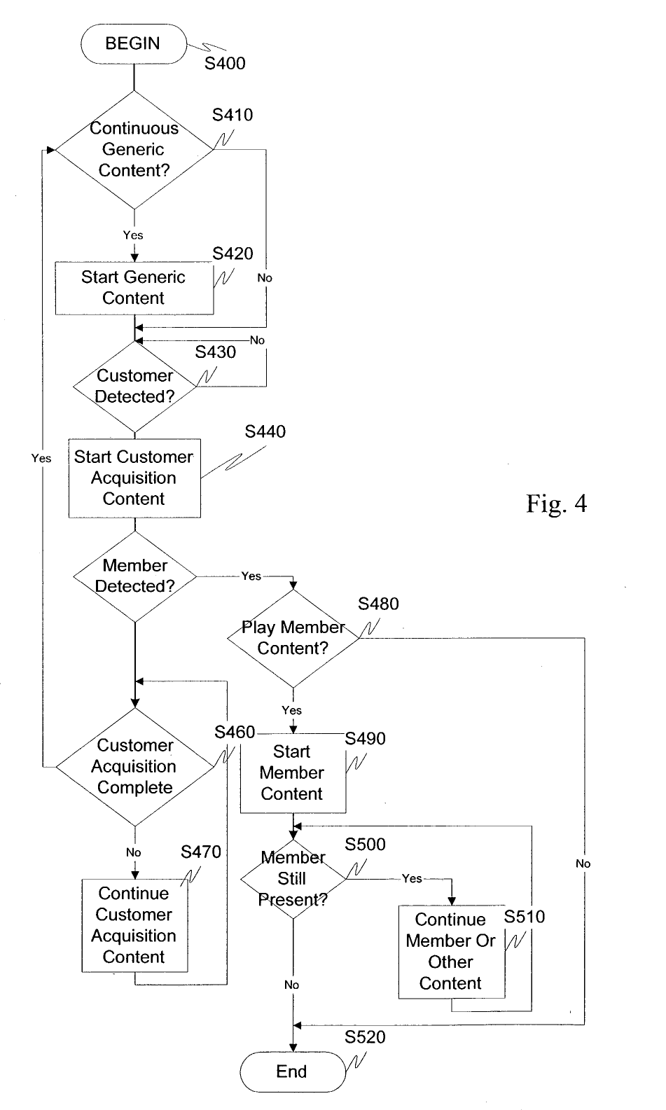

FIG. 4 illustrates a second exemplary method for providing content according to this invention. For example, in this exemplary method, the content is continuously presented to acquire new customers. Specifically, control begins in step S400 and continues to step S410. In step S410, a determination is made whether continuous generic content is to be presented. If continuous generic content is to be presented, control continues to step S420. Otherwise, control jumps to step S430. In step S420, the generic content is played. Control then continues to step S430.

In step S430, a determination is made whether a customer has been detected. If a customer has been detected, control continues to step S440. Otherwise, control jumps back to step S430.

In step S440, playing of the customer acquisition content commences. This can include asking the customer for an identification. In step S450, a determination is made whether the customer is a member. If the customer is a member, control jumps to step S480. Otherwise, control continues to step S450. Next, in step S460, a determination is made whether the customer acquisition is complete. If the customer acquisition is complete, control jumps back to step S410. Otherwise, control jumps to step S470. In step S470, the customer acquisition content continues playing. Control then continues back to step S460.

In step S480, a determination is made whether content specific to the member is to be played. If contents specific to the member is not to be played, control jumps to step S520 where the control sequence ends. Otherwise, control continues to step S490 where playing of the member content commences. Next, in step S500 a determination is made whether the members presence continues to be detected. If the member is present, control continues to step S510 where member or other content is played. Otherwise, control jumps to step S520 where the control sequence ends.

In addition to the audio/video/multimedia content discussed above, the customer acquisition system can also present a customer with different types of content. For example, some specific member loyalty systems may require the user to fill out a form to enjoy the benefits associated with that program. In this instance, for example, an electronic form could be presented to the user interface 100 which the customer could fill it out on the spot via, for example, a touch sensitive screen. Alternatively, a printing system, or means for acquiring the customers address could be obtained such that the customer acquisition system 10 could print out a membership form, or secure the customer address information and forward the appropriate membership materials at a later time.

Furthermore, as discussed previously, the customer acquisition system can be dynamic such that, for example, if the customer indicates via the user interface 100 that they want to become a member, the system could automatically prompt the customer for an identification, such as a credit card number, an ID number, a drivers license, name, ID tag, or the like, that can be associated with a profile identifying that particular customer as a member.

Additionally, the customer acquisition system need not be limited to one specific “product” line. For example, the customer acquisition system can bridge multiple product and/or service lines and use one or more pieces of information therein to aid in determining content, membership privileges, or the like.

Still further, the customer acquisition system can cooperate with the profile module 80 such that once a customer has been identified as a member, information in the profile module 80 further governs how the content determination module 70 determines the type of content, if any, to be presented to a customer. For example, the profile may be editable by a customer such that the customer can specify they only want to see a particular type of advertisement, or particular type of product promotion. Likewise, the member could specify in their profile that they do not want to receive any content upon identifying to the customer acquisition system that they are a member. Notwithstanding the above, the customer acquisition system may still be able to monitor the activities of the customer and maintain, for example, a historical log of their transactions with the customer acquisition system.

The above-described systems and methods can be implemented on a loyalty system, marketing system, advertising system, or the like, or on a separate programmed general purpose computer having customer loyalty capabilities. Additionally, the systems and methods of this invention can be implemented on a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, stored as instructions on a recordable media, or the like. In general, any device capable of implementing a state machine that is in turn capable of implementing the flowcharts illustrated herein can be used to implement the system according to this invention.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized. The systems and methods illustrated herein however can be readily implemented in hardware and/or software using any known or later developed systems or structures, devices and/or software by those of ordinary skill in the applicable art from the functional description provided herein and with a general basic knowledge of the computer and loyalty system arts.

Moreover, the disclosed methods may be readily implemented in software executed on programmed general purpose computer, a special purpose computer, a microprocessor, or the like. In these instances, the systems and methods of this invention can be implemented as program embedded on personal computer such as JAVA® or CGI script, as a resource residing on a server or graphics workstation, as a routine embedded in a dedicated encoding/decoding system, or the like. The system can also be implemented by physically incorporating the system and method into a software and/or hardware system, such as the hardware and software systems of an image processor.

It is, therefore, apparent that there has been provided, in accordance with the present invention, systems and methods for customer acquisition. While this invention has been described in conjunction with a number of embodiments, it is evident that many alternatives, modifications and variations would be or are apparent to those of ordinary skill in the applicable arts. Accordingly, it is intended to embrace all such alternatives, modifications, equivalents and variations that are within the spirit and scope of this invention.

1. A customer acquisition system comprising:
a detector module;
a member determination module; and
a content determination module, wherein the content determination module determines content to be distributed to a presentation device based at least on the detector module and the member determination module.

2. The system of claim 1, further comprising a profile module, the content determination module further cooperating with the profile module to determine content to be distributed to the presentation device.

3. The system of claim 1, further comprising an interface module that allows one or more of a customer and administrator to interact with the customer acquisition system.

4. The system of claim 1, wherein the detector module is at least one of a proximity detector, an electrical detector, an electro-mechanical detector, a magnetic detector, an inductive detector, a capacitive detector, an optical detector, a credit card reader, a switch and an RFID detector.

5. The system of claim 1, wherein the content to be distributed for a member customer is different than the content to be distributed to a non-member customer.

6. The system of claim 1, wherein content is continuously streamed to the presentation device.

7. The system of claim 1, wherein content is streamed to the presentation device if a customer is detected by the detector module.

8. The system of claim 1, wherein the profile module stores information about one or more member customers.

9. The system of claim 1, further comprising a content storage device.

10. The system of claim 1, wherein the customer acquisition system operates in a gas station environment.

11. A method of acquiring customers comprising:
determining if a user is a member;
selecting content based on the determining step; and
presenting the content to the user, wherein the content at least one of member acquisition content and member content.

12. The method of claim 11, further comprising detecting the presence of the user.

13. The method of claim 11, further comprising ceasing presentation of the content in the absence of a user.

14. The method of claim 11, wherein the member content is based on a member profile.

15. The method of claim 11, wherein the content is at least one of audio, video, multimedia and live streaming content.

16. The method of claim 11, wherein content is dynamically selected based on one or more of user presence, user identity and profile information.

17. The method of claim 11, wherein the content switches from member acquisition content to member content upon determining the user is a member.

18. The method of claim 1, further comprising dynamically interacting with the user to secure membership.

19. The method of claim 1, further comprising continuously presenting generic content until a user is detected.

20. The method of claim 1, wherein the method is implemented i association with a gas pump.
